(19) United States
(12) Patent Application Publication
(10) Pub. No.: US 2016/0380551 A1
(43) Pub. Date: Dec. 29, 2016

(54) CONVERTER ARRANGEMENT HAVING MULTI-STEP CONVERTERS CONNECTED IN PARALLEL AND METHOD FOR CONTROLLING THESE

(71) Applicant: SIEMENS AKTIENGESELISCHAFT, München (DE)

(72) Inventors: WOLFGANG HOERGER, HAUSEN (DE); MARTIN PIESCHEL, NUERNBERG (DE)

(21) Appl. No.: 14/901,500

(22) PCT Filed: Jun. 5, 2014
(86) PCT No.: PCT/EP2014/061703

§ 371 Date: Dec. 28, 2015

(30) Foreign Application Priority Data
Jun. 27, 2013 (DE) 102013212426.0

(51) Int. Cl. H02M 7/04; H02M 1/12; H02M 7/44

(52) U.S. Cl. CPC H02M 7/04; H02M 7/44; H02M 1/12

(57) ABSTRACT

A method for controlling a plurality of multi-level converters, which are closed in parallel at alternating-voltage connections thereof and which each have a series arrangement of two-pole sub-modules. Each of the sub-modules has at least two controllable electronic switches and an energy storage device, wherein the controllable electronic switches are connected in series forming a series arrangement and the series arrangement is connected in parallel with the energy storage device. In the method, a stepped voltage curve is produced at the particular alternating-voltage connection of the multi-level converters. The voltage curve of a second multi-level converter is offset in time in relation to the voltage curve of a first multi-level converter. A converter assembly includes a device for the time delay of the alternating-voltage curve of at least one multi-level converter in relation to the alternating-voltage curve of a further multi-level converter.

The invention relates to a converter arrangement comprising a multiplicity of multi-step converters comprising in each case a series circuit of two-pole submodules, each of the multi-step converters having an alternating-voltage terminal at which a step-shaped voltage curve can be generated, and the multi-step converters being connected in parallel via their alternating-voltage terminals.

Furthermore, the invention relates to a method for controlling the converter arrangement.

In DE 101 03 031 B4, a modular multi-step converter of the type initially mentioned is disclosed, the multi-step converter being connected via its alternating-voltage terminals to three phases of an alternating-current system. To each of the three alternating-voltage terminals of the multi-step converter, two branches of series-connected two-pole submodules are allocated. Each submodule comprises controllable electronic switches and an energy store. The controllable electronic switches are connected in series, forming a series circuit, the series circuit being connected in parallel with the energy store. By suitably driving the submodules, the multi-step converter can generate a step-shaped periodic alternating voltage with predetermined frequency and amplitude. The number N of the submodules connected in series in one branch defines at the same time the number N of (positive or negative) voltage steps which can be generated at the alternating-voltage output of the respective multistep converter. When using such multi-step converters, the harmonics (system reactions) resulting from the stepped form of the alternating output voltage generated are always found to be disadvantageous. In individual cases, the harmonics can lead to system resonances and thus to current and/or voltage peaks so that impairments can occur at consumers.

For some applications, for example in high-voltage direct-current transmission installations (HVT installations) or in devices for reactive-power compensation, it is of advantage to operate a number of such multi-step converters in parallel, the multi-step converters connected in parallel being connected to a multi-phase busbar.

For a long time, there has, therefore, been a great demand for converter arrangements with multi-step converters operated in parallel and for methods for controlling these, in which a proportion of harmonics in the alternating output the voltage can be reduced.

It is known that, in a diode-clamped voltage source converter (VSC), a flying-capacitor VSC, cascaded H-bridge VSC or a modular multi-step converter (MMC), the degree of harmonics can be reduced by increasing the switching frequency. However, this leads to additional electrical losses which increase the cost of operating the multi-step converters.

Another method for avoiding harmonics is the use of passive filters. However, these need additional mounting area which increases the total mounting area needed for the converter arrangement. Passive filters also cause thermal losses. Furthermore, the effectiveness of filters depends on the system conditions which can change with time, are not completely known and/or depend on aging effects of components.

In their contribution “Single-Phase Multilevel PWM Inverter Topologies Using Coupled Inductors”; IEEE Transactions on Power Electronics, Vol. 24, May 2009, J. Salmon, A. M. Knight, J. Ewanchuk describe the use of special coupling inductances.

In DE 42 32 356 A1, the control of a parallel circuit of converters is described in which a selected harmonic is suppressed by shifting the voltage of one of the converters in phase with respect to the voltage of a further converter by half the period of the harmonic. However, driving multi-step converters of the type initially mentioned for suppressing the total proportion of harmonics is not mentioned in DE 42 32 356 A1.

It is the object of the present invention, therefore, to propose a method for controlling the converter arrangement having a plurality of multi-step converters in which the proportion of harmonics of the alternating output voltage is reduced.

The object is achieved by the fact that the voltage curve at the alternating-voltage terminal of a second multi-step converter is offset in time with respect to the voltage curve at the alternating-voltage terminal of a first multi-step converter.

It is also the object of the present invention to propose a converter arrangement of the above type which provides for a control of the multi-step converters in which the proportion of harmonics of the alternating output voltage of the converter arrangement can be reduced.

The object is achieved by the fact that the converter arrangement comprises means for delaying the alternating-voltage curve of at least one multi-step converter in time with respect to the alternating-voltage curve of a further multi-step converter.

In the method according to the invention, the offset in time of the voltage curves leads to the harmonics resulting from the stepped shape of the alternating voltage generated by the multi-step converters becoming superimposed in such a manner that they are at least partially extinguished.

Under suitable conditions, an attenuation of the harmonics by a factor of 1/M can be achieved, M designating the number of multi-step converters connected in parallel. The harmonics greatly attenuated in this manner have the M-fold frequency of a single multi-step converter driven and, in general, have no longer an interfering influence on the system.

Advantageously, a switching frequency of the multi-step converters which corresponds to the inverse of the period of the clock signal can also be reduced to such an extent that the harmonics produced are below a limit value to be met. This lowers the operating losses of the individual multi-step converters.

The method according to the invention is suitable both for use in HVT systems and in the reactive-power compensation in alternating-voltage systems.

Preferably, a central control unit provided for this purpose conducts drive signals to the multi-step converters. In this context, the central control unit conducts an undelayed drive signal to the first multi-step converter and a drive signal delayed by a difference time to the second multi-step converter.

According to a preferred embodiment of the invention, the difference time is predetermined in dependence on the number N of voltage steps which can be generated and on a time interval TA between two successive drive signals.

It is found to be particularly suitable to select the difference time to be proportional to TA and inversely proportional to N. For example, the difference time can be represented by a formula t=c*TA/N. t here designates the difference time and c designates a constant which can be located within a range of values between 0 and 2, preferably between 0.2 and 0.8.

According to a further embodiment of the invention, the central control unit specifies for each of the multi-step converters both a drive clock and a converter voltage to be set. The converter voltage specified can be converted, for example, by means of phase-shifted pulse-width modulation into a corresponding drive for the multi-step converters. The predetermined drive clock can be present in the form of a periodic carrier signal. The pulse-width modulation for driving the individual submodules of the multi-step converters then suitably comprises a shifting of the carrier signal by a predetermined phase angle.

However, any other suitable method can also be used for driving the multi-step converters such as, for example, that described in WO 2008/086760 A1.

If the converter arrangement comprises more than two multi-step converters, all multi-step converters, apart from the first multi-step converter, are preferably driven delayed. If the drive signal to the second multi-step converter is delayed by the difference time, the drive signal can be delayed by twice the difference time to a third multi-step converter, by three-times the difference time to a fourth multi-step converter, etc, for example.

According to the invention, the converter arrangement comprises means for delaying the step-shaped alternating-voltage curve of at least one multi-step converter in time with respect to the alternating-voltage curve of a further multi-step converter.

The multi-step converters preferably comprise in each case a control unit which, for example, can be designed in the form of a Module Management System (MMS). The converter arrangement preferably also has a central control unit for providing drive signals to the control units. The central control unit is equipped with one or more delay elements so that the drive signals can be delayed in time by means of the delay elements.

If the central control unit specifies a voltage to be converted, each control unit is preferably responsible for a conversion of the predetermined voltage at the converter terminals by driving the multi-step converters.

The multi-step converters are suitably connected to a busbar via a coupling inductance. The coupling inductance can be designed as a choke for reducing high-frequency currents.

According to one embodiment of the invention, the busbar is connected to an alternating-voltage system. The alternating-voltage system is preferably a three-phase system. In this context, each multi-step converter is connected to three busbars, each busbar corresponding to one phase of the system.

The two-pole submodules are designed preferably as half-bridge circuits or full-bridge circuits.

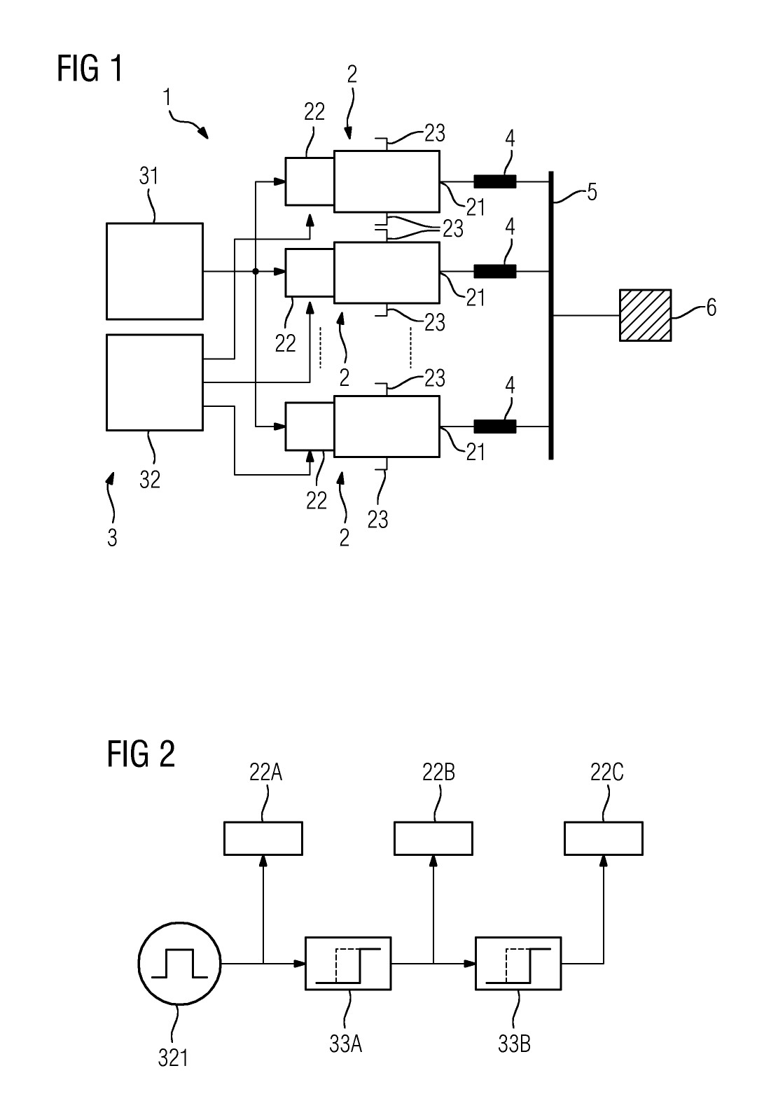

In the text which follows, the invention will be explained in greater detail by means of FIGS. 1 to 7.

FIG. 1 shows the diagrammatic structure of a converter arrangement according to the invention;

FIG. 2 shows a time delay of drive signals according to the invention in a diagrammatic representation;

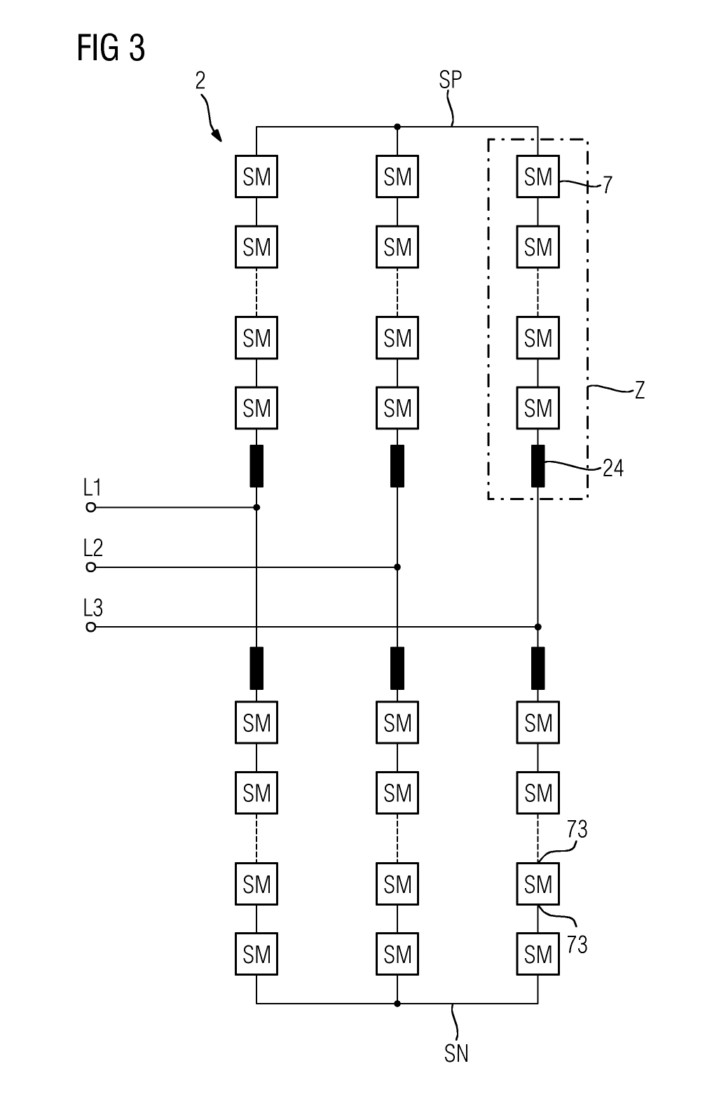

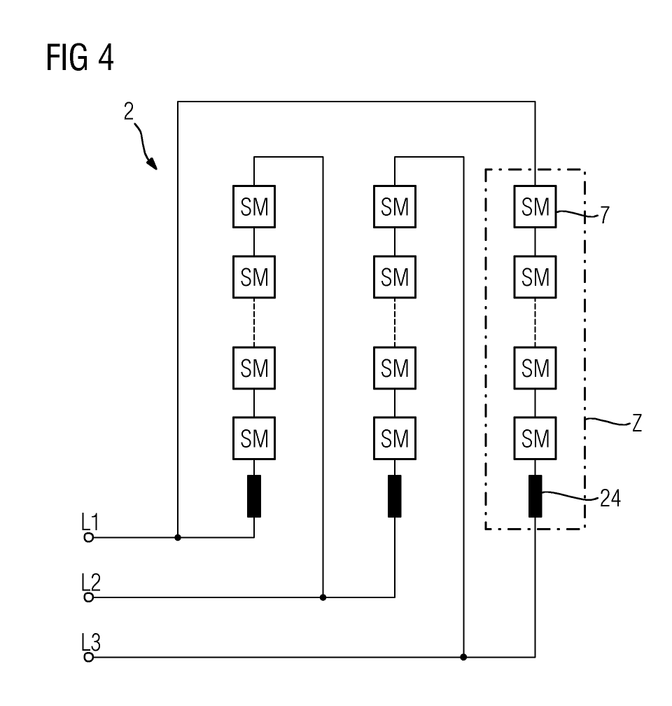

FIGS. 3 and 4 show exemplary embodiments of multi-step converters of the converter arrangement according to the invention in a diagrammatic representation;

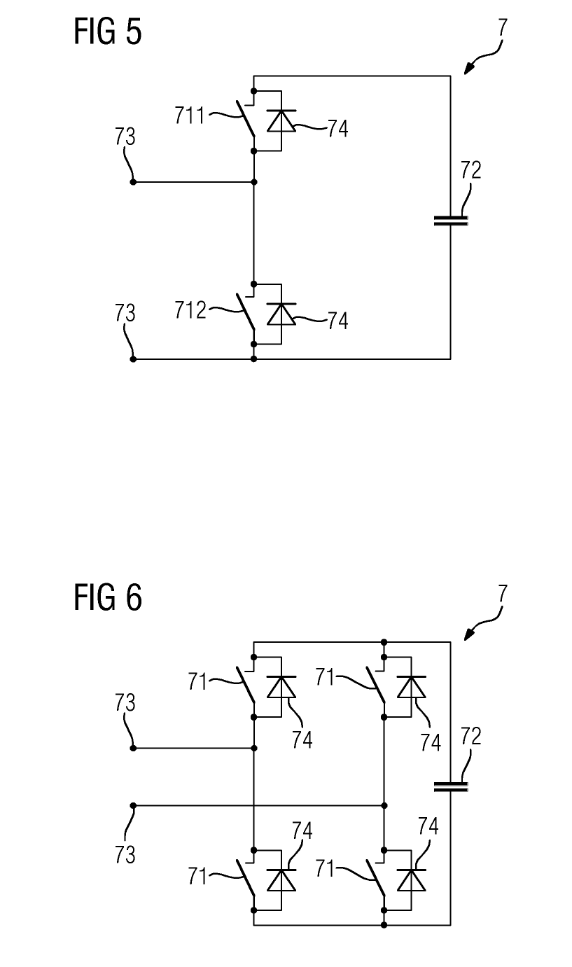

FIGS. 5 and 6 show in each case an exemplary embodiment of a submodule in a diagrammatic representation;

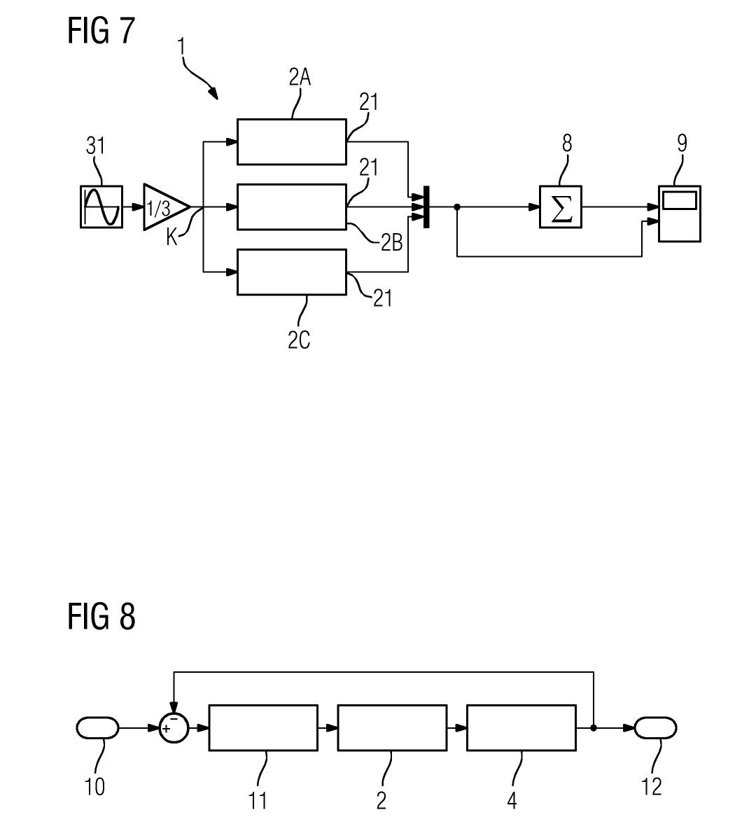

FIG. 7 shows an example of a simulation of the converter arrangement according to the invention in a diagrammatic representation;

FIG. 8 shows a controlled system of the simulation from FIG. 5 in a diagrammatic representation;

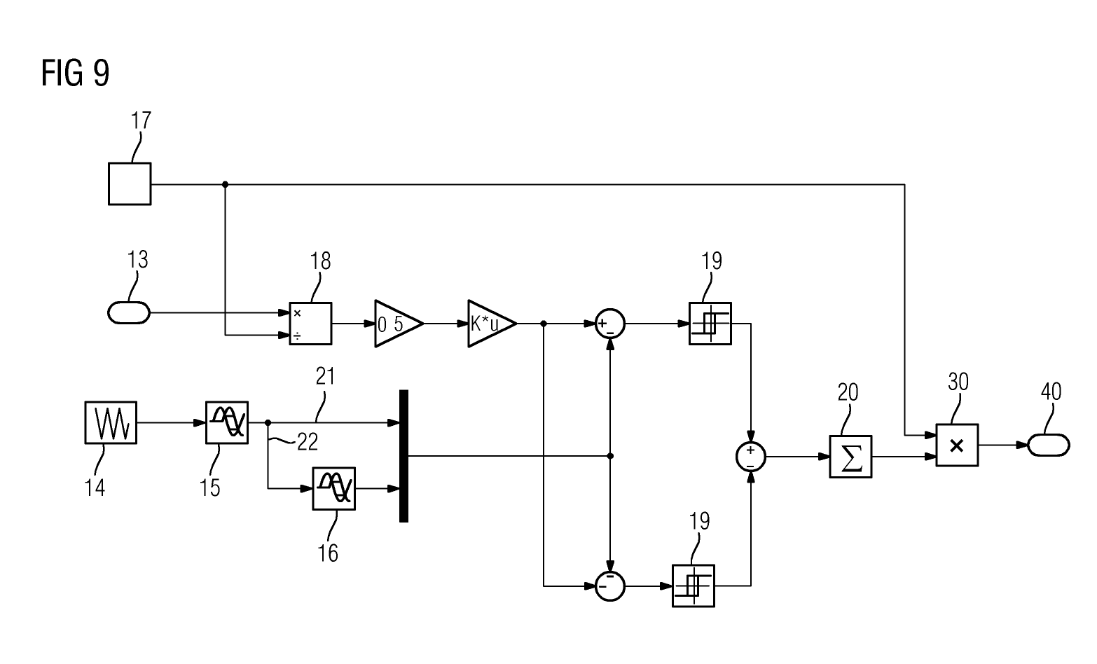

FIG. 9 shows an arrangement for driving the multi-step converter according to the simulation from FIGS. 5 and 6 in a diagrammatic representation.

In detail, FIG. 1 shows in a diagrammatic representation the basic structure of an exemplary embodiment of the converter arrangement 1 according to the invention. The converter arrangement 1 shown comprises a plurality of multi-step converters 2 connected in parallel. Each of the multi-step converters 2 has an alternating-voltage terminal 21. The multi-step converters 2 are connected to a busbar 5 via their alternating-voltage terminal 21 and via a coupling inductance 4. The busbar 5, in turn, is connected to an alternating-voltage system 6, for example one phase of a three-phase system.

Each of the multi-step converters 2 comprises a control unit 22 which are provided for converting a specified voltage of a central control unit 3 into a drive for the multi-step converters 2.

The central control unit 3 has means 31 for generating the specified voltage and a unit 32 for generating a drive signal.

Each of the multi-step converters 2 receives from the central control unit 3 the specified current target value and the drive signal which is designed as a periodic clock carrier signal. In this context, the drive signal of a first multi-step converter is undelayed and the drive signal of a further multi-step converter is offset in time with respect to the undelayed drive signal. The drive signals of all multi-step converters, apart from the first multi-step converter, are preferably delayed in each case by a difference time, all difference times being different from one another.

By means of the control units 22, the respective drive signal and the specified current target value are converted into a drive for the semiconductor switches 71 (compare FIGS. 5, 6) of the multi-step converters 2. Due to the delay of the drive signals, the resultant alternating-voltage curves at the alternating-voltage terminals 21 of the multi-step converters 2 are offset in time with respect to one another.

If the multi-step converter arrangement is to be used as part of an HVDC transmission system, each multi-step converter 2 has direct-voltage terminals 23 for linkage to in each case one negative and one positive voltage pole or one ground terminal, respectively.

The multi-step converters 2 can be configured preferably as modular multi-step converters (MMC) (compare FIGS. 3, 4).

By means of FIG. 2, the time offset of the drive signals is to be explained in its formation by means of an exemplary structure.

The unit 32 for generating the drive signal (compare FIG. 1) comprises a clock generator 321. The drive signal generated by the clock generator 321 is conducted undelayed to the control unit 22A of the first multi-step converter. At the same time, the undelayed drive signal is conducted to a first delay element 33A by means of which the drive signal is delayed in time. The control unit 22B thus receives the drive signal delayed by the delay element 33A. Furthermore, the drive signal delayed by the delay element 33A is conducted onto the delay element 33B. Finally, the control unit 22C receives the drive signal delayed twice together by means of the two delay elements 33A and 33B.

The structure of the multi-step converters 2 according to two embodiments is shown diagrammatically in FIGS. 3 and 4. These multi-step converters, known from the prior art, can be used preferably in the converter arrangement 1 according to the invention. However, the invention is not restricted to the exclusive use of the multi-step converters shown.

The multi-step converter 2 of FIG. 3 comprises three alternating-voltage terminals L1, L2, L3. By means of the alternating-voltage terminals L1, L2, L3, the multi-step converter 2 is connected to a three-phase power system (not shown). The multi-step converter shown in FIG. 3 can be used as rectifier or as inverter. The multi-step converter 2 also comprises six branches Z which have in each case a series circuit of N two-pole submodules 7 of identical construction and one inductance 24. Each of the branches Z is connected either to a positive busbar SP or to a negative busbar SN. The potential difference between the two terminals 73 of each two-pole submodule 7 is called submodule terminal voltage. Each submodule 7 can assume a first switching state in which the associated submodule terminal voltage is equal to zero; and assume a second switching state in which the submodule terminal voltage is equal to a value different from zero. By suitably driving the submodule 7 of the multi-step converter 2, for example k submodules 7 connected in series between the positive busbar SP and the negative busbar SN can be switched accordingly into the second switching state; the remaining N-k submodules are switched into the first switching state. As a result, a potential difference U_{PN} is generated between the busbars SP and SN which corresponds to the number k submodules 7 which are in the second switching state. If, for example, the energy stores of the submodules are precharged to a uniform voltage amplitude U_{C}, the potential difference will be U_{PN}=k*U_{C}. The potential at terminal L1 which is defined, for example, as potential difference with respect to busbar SN, is then proportional to the number of subsystems located in branch Z between L1 and SN which are in the second switching state. The number of (positive or negative, respectively) voltage steps which can be generated at a maximum between L1 and SN (or SP, respectively) is thus equal to the number N of series-connected submodules 7 in an associated branch Z. This correspondingly applies to terminals L2 and L3.

FIG. 4 shows a further embodiment of the multi-step converter 2. The multi-step converter 2 of FIG. 4 has three branches Z of series-connected submodules 7. In this arrangement, the three alternating-voltage terminals L1, L2, L3 are connected to one another in a triangular circuit via the three branches Z. The multi-step converter 2 of FIG. 4 is preferably used for reactive-power compensation of a three-phase alternating-current system.

By means of FIGS. 5 and 6, two exemplary embodiments of submodules 7 of the converter arrangement according to the invention are to be described.

Submodule 7 of FIG. 5 is implemented as half-bridge circuit and has two terminals 73, two controllable electronic switches 711, 712 and one energy store 72.

The two controllable electronic switches 711, 712 are connected in series, forming a series circuit. The series circuit of the electronic switches 711, 712 is connected in parallel with the energy store 72 in this arrangement. The controllable electronic switches 711, 712 are implemented by semiconductors such as IGBT or MOS-FET. With each of the controllable electronic switches 711, 712, a diode 74 is connected in antiparallel. The antiparallel diodes 74 can be discrete components or integrated in the semiconductor structure of the controllable electronic switches 711, 712. The energy store 72 is implemented as storage capacitor or as a capacitor battery of a number of storage capacitors.

The first switching state of submodule 7 is characterized by the fact that the electronic switch 712 is switched on whilst the electronic switch 711 is switched off. If the electronic switch 711 is switched on whilst the electronic switch 712 is switched off, the submodule 7 is in the second switching state in which essentially the voltage of the energy store 72 is dropped across the submodule terminals 73. If both electronic switches 711, 712 are switched off, this ensures that energy is delivered undesirably in the case of an external fault (for example in the case of terminal short circuit).

In the exemplary embodiment shown in FIG. 6, the two-pole submodule 7 with the two terminals 73 is implemented as a full bridge. The submodule 7 of FIG. 6 comprises two series circuits of electronic switches 71, to which in each case an antiparallel diode 74 is allocated. In parallel with the two series circuits, an energy store 72 in the form of a storage capacitor or a capacitor battery is connected. Similar to FIG. 5, the first and the second switching state of the submodule 7 can be created also in the full bridge of FIG. 6 by switching the electronic switches 74 on or off, respectively. In addition, the submodule 7, as full bridge, can also create a negative switching state.

Naturally, the configurations shown in FIGS. 3 to 6 should not exclude that the multi-step converters 2 and the submodules 7 comprise no further components such as, for example, measuring devices not shown in the figures.

FIG. 7 shows diagrammatically a test configuration for simulating the method according to the invention for controlling the converter arrangement 1. In this exemplary embodiment, the converter arrangement 1 comprises three multi-step converters 2A, 2B, 2C. The multi-step converters 2A, 2B, 2C are connected in parallel via their alternating-voltage terminals 21.

A specified current target value 31 is conducted via a branch at a node K to the multi-step converters 2A, 2B, 2C connected in parallel. According to the specified current target value, a step-shaped voltage curve is generated at each of the alternating-voltage terminals 21, the voltage curves being offset in time with respect to one another. Following this, the three voltage curves are added in an adding element 8 and compared with the individual voltage curves, the comparison being displayed in a means of presentation. By means of the detection and graphic presentation of the voltage curves, the proportion of harmonics suppressed in the result of the method can be made visible in the voltage curve and, if necessary, quantified in the individual case.

FIG. 8 shows the basic course of a controlled system between node K and the alternating-voltage terminal 21 (compare FIG. 7) of one of the multi-step converters 2A, 2B, 2C. This presentation applies correspondingly to the remaining multi-step converters.

At input 10 of the controlled system, the specified current target value which exhibits a sinusoidal curve in time is provided and forwarded to a current controller 11. In the exemplary embodiment of FIG. 8, the current controller 11 is implemented as a PI controller. In this arrangement, the PI controller is characterized by a transfer function of the form U(s)=(s+200/(100*pi))/s, pi designating the circle constant (Ludolph's constant). In this context, it is naturally also conceivable to use other controllers having transfer functions deviating from this. The specified current target value is converted into a specified converter voltage by the PI controller. The control unit of the multi-step converter 2 processes the specified converter voltage and converts it by means of phase-shifted PWM (pulse-width modulation) into switching commands for the electronic switches of the submodules. The resultant voltage is output at output 12 of the controlled system, the voltage being adapted further by means of the coupling inductance 4, the inductance of which is 636.7 pH and the ohmic resistance of which is approx. 1 mOhm in the present case. The coupling inductance 4 generally also has an ohmic component apart from an inductive component. In the exemplary embodiment of FIG. 8, therefore, a transfer function of the form U(s)=1000/((200/100*pi)*s+1) is allocated to the coupling inductance 4. However, other transfer functions are also conceivable in this context.

FIG. 9 shows a diagrammatic representation of the phase-shifted pulse-width modulation of the simulated exemplary embodiment of FIGS. 7 and 8. The phase-shifted pulse-width modulation is performed correspondingly for each of the three multi-step converters 2A, 2B, 2C in this arrangement.

In this exemplary embodiment, the multi-step converter 2A, 2B, 2C comprises two submodules in each branch Z. However, the method for driving can be extended correspondingly to each greater number of submodules.

A clock carrier signal of the drive system is generated by means of a sawtooth generator and conducted to a first delay element 15. The first delay element 15 delays the clock carrier signal according to the following rule: the clock signal for the multi-step converter 2A is not delayed; the clock carrier signal for the multi-step converter 2B is delayed by a difference time; the clock carrier signal for the multi-step converter 2C is delayed by twice the difference time. In this context, the sawtooth-shaped clock carrier signal has a frequency of 1 kHz. The difference time is 83.3 μs.

The clock carrier signal is subsequently forwarded to the first submodule without further delay which is indicated by a first branch Z1 in FIG. 9. The clock carrier signal to the second submodule is conducted to a second delay element 16 via a second branch Z2 so that an additionally delayed clock carrier signal is allocated to the second submodule. The additional delay, which is usually expressed as phase shift with respect to the periodic clock carrier signal is 90° in the exemplary embodiment shown in FIG. 9. More generally, it applies that for the case of m submodules, the phase shift should be 180°/m which is described, for example, in the essay “Multicarrier PWM With DC-Link Ripple Feedforward for Multilevel Inverters”; Power Electronics, IEEE Transactions on (Volume: 23, Issue: 1), 2008, by S. Kouro et al.

The specified voltage target value determined by the current controller 11 is provided at input 13 of the drive system. This is standardized by a multiplier 18, taking into consideration the submodule voltage which is provided by a measuring device 17.

The clock carrier signals of the two submodules are then compared with the standardized voltage target value by means of comparators 19, from which the switching state is determined in each case for each of the two submodules. The voltages dropped across the terminals of the submodules according to their switching states are added by means of an adding element 20. Finally, the resultant converter voltage is formed by means of a multiplier 30 and conducted to output 40.

### LIST OF REFERENCE DESIGNATIONS

1 Converter arrangement
2, 2A, 2B, 2C Multi-step converter
21 Alternating-voltage terminal
22, 22A, 22B, 22C Control unit
23 Direct-voltage terminal
3 Central control unit
31 Specified current target value
32 Drive signal generation
33A, 33B Delay element
4 Coupling inductance
5 Busbar
6 Alternating-voltage system
7 Submodule
71, 711, 712 Electronic switch
72 Energy store
73 Submodule terminal
74 Diode
8 Adding element
9 Means of presentation
10 Controlled system input
11 Current controller
12 Controlled system output
13 Drive system input
14 Sawtooth generator
15 First delay element
16 Second delay element
17 Measuring device
18 Multiplier
19 Comparator
20 Adding element
30 Multiplier
40 Drive system output
K Node
L1, L2, L3 Alternating-voltage terminal of a three-phase power system
SN Negative busbar
SP Positive busbar
Z Branch
Z1 First branch
Z2 second branch

1-12. (canceled)

13. A method for controlling a multiplicity of multi-level converters,
providing the multi-level converters connected in parallel at alternating-voltage terminals thereof, each multi-level converter including a series circuit of two-pole submodules; wherein each two-pole submodule has at least two controllable electronic switches and one energy storage device, and the controllable electronic switches are connected in series, forming a series circuit, and the series circuit is connected in parallel with the energy storage device;
generating a step-shaped voltage curve at a respective alternating-voltage terminal, and temporally offsetting a voltage curve of a further multi-level converter with respect to the voltage curve of a first multi-level converter.

14. The method according to claim 13, which comprises transmitting drive signals from a central control unit to the multi-level converters, wherein the central control unit transmits an undelayed drive signal to a first multi-level converter and transmits a drive signal delayed by a time differential to a second multi-level converter.

15. The method according to claim 14, which comprises generating a number N voltage steps by each multi-level converter and predetermining each time differential in dependence on N and on a time interval TA between two successive drive signals.

16. The method according to claim 15, wherein the time differential is proportional to TA and inversely proportional to N.

17. The method according to claim 14, which comprises specifying with the central control unit a converter voltage to be set, and converting the specified converter voltage into a corresponding drive for the multi-level converters by way of phase-shifted pulse-width modulation.

18. The method according to claim 17, wherein the phase-shifted pulse-width modulation comprises shifting a phase of a periodic carrier signal for driving the individual submodules of the multi-level converters.

19. A converter arrangement, comprising:
a multiplicity of multi-level converters connected in parallel at alternating-voltage terminals thereof;
each of said multi-level converters having a series circuit of two-pole submodules each including at least two controllable electronic switches and one energy storage device;
said controllable electronic switches being connected in series, forming a series circuit, and said series circuit being connected in parallel with said energy storage device;
each of said alternating-voltage terminals being configured to carry a voltage with a step-shaped voltage curve;
means for delaying the alternating-voltage curve of at least one of said multi-level converters in time with respect to the alternating-voltage curve of a further one of said multi-level converters.

20. The converter arrangement according to claim 19, wherein each of said multi-level converters comprises a control unit and the converter arrangement further comprises a central control unit for providing drive signals to said control units of said multi-level converters, and wherein said central control unit is equipped with delay elements configured to temporally delay the drive signals.

21. The converter arrangement according to claim 20, which comprises a coupling inductance connecting said multi-level converters to a busbar.

22. The converter arrangement according to claim 21, wherein said busbar is connected to an alternating-voltage system.

23. The converter arrangement according to claim 20, wherein said control units are configured to drive the individual said submodules of said multi-level converters by way of phase-shifted pulse-width modulation.

24. The converter arrangement according to claim 19, wherein said submodules are half-bridge circuits.

25. The converter arrangement according to claim 19, wherein said submodules are full-bridge circuits.
